(19) United States
(12) Patent Application Publication
(10) Pub. No.: US 2026/0037245 A1
(43) Pub. Date: Feb. 5, 2026

(54) MANAGING DATA FOR USE IN UPDATING OPERATION OF DATA PROCESSING SYSTEMS

(71) Applicant: Dell Products L.P., Round Rock, TX (US)

(72) Inventors: OFIR EZRIELEV, Be'er Sheva (IL); HANNA YEHUDA, Acton, MA (US); TSEHSIN JASON LIU, Wellesley, MA (US); YONIT LOPATINSKI, Shomria (IL)

(21) Appl. No.: 18/788,482

(22) Filed: Jul. 30, 2024

(51) Int. Cl. G06F 8/65; G06N 5/04

(52) U.S. Cl. CPC G06F 8/65; G06N 5/04

(57) ABSTRACT

Methods and systems for managing operation of one or more data processing systems are disclosed. To manage the operation, a mixed input data set may be obtained. The mixed input data set may include live data and at least a portion of forecasted data related to operational conditions for the one or more data processing systems. The forecasted data may be generated by external data sources using proprietary methods. A sampling process may be performed so that variability within the forecasted data may be represented in the mixed input data set. At least the mixed input data set may then be used determine whether a policy is invoked. If the policy is invoked, an action set included in the policy may be used to update operation of the one or more data processing systems to hedge against a risk of an undesired outcome from the occurrence of the state.

### FIELD

Embodiments disclosed herein relate generally to managing operation of data processing systems. More particularly, embodiments disclosed herein relate to systems and methods to manage data for use in updating operation of data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show diagrams illustrating data flows in accordance with an embodiment.

FIGS. 3A-3B show flow diagrams illustrating a method of managing operation of data processing systems in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of data processing systems. The data processing systems may provide computer-implemented services. A state may be based on any number of operational conditions for the data processing systems. Changes in the state (e.g., changes to an environment in which the data processing systems operate) may impact an ability of the data processing systems to provide the computer-implemented services as desired.

Therefore, the operation of the data processing systems may be managed using a set of policies. Each policy of the set of policies may include an action set usable to update the operation of the data processing systems and the action set may be keyed to information indicating the operational conditions (e.g., current operational conditions, predicted operational conditions, simulated operational conditions).

However, a quality and/or reliability of the computer-implemented services provided by the data processing systems may be impacted by a likelihood of identifying relevant policies as operational conditions change. To increase a likelihood of identifying the relevant policies and updating the operation of the data processing systems in a manner that meets needs of a downstream consumer of the computer-implemented services, forecasted data may be obtained from external data sources.

The forecasted data may include forecasted data values related to the operational conditions and may be used to increase a range of data sources from which the information indicating the operational conditions is obtained. The forecasted data may include predictions (e.g., inferences, simulations) generated by the external data sources (e.g., third parties) using proprietary methods. The forecasted data may, therefore, not include quantifications of uncertainty in the forecasted data values (e.g., any statistical characterizations indicating variability in the forecasted data). In contrast, measurements obtained from live data (e.g., from data collectors) may include quantifications of uncertainty in the measurements (e.g., based on characteristics of the data collectors and/or data collection methods), information about which may be available.

The forecasted data values may include sub-sets of corresponding forecasted data values that each include a prediction for a same condition at a same point in time. Each forecasted data value within a sub-set of corresponding forecasted data values may be obtained from a different external data source of the external data sources. For example, a sub-set of corresponding forecasted data values may include five predictions for wind speed at a geographical location at a future point in time each generated by a different external data source. Due to a lack of knowledge of forecasting methods and/or forecasting models used to generate the forecasted data values, the forecasted data values may display a degree of variability between corresponding predictions of a sub-set of corresponding forecasted data values.

To utilize the forecasted data in view of the variability between corresponding forecasted data values, a sampling process may be performed. During the sampling process, at least a portion of the forecasted data values may be added to a mixed input data set along with the live data. By sampling the forecasted data during generation of the mixed input data set, variability within the forecasted data values may be represented.

The mixed input data set may be used to determine whether a policy of the set of existing policies is invoked. To do so, conditions indicated by the mixed input data set and/or predictions (e.g., inferences, simulations) generated by at least one inference model using the mixed input data set may be compared to the set of existing policies. The policy may be invoked if the policy is keyed to a portion of the mixed input data set, a portion of predictions generated using the mixed input data set, etc.

An action set obtained from the policy may be performed to update operation of one or more data processing systems. By performing the action set, the one or more data processing systems may be used to provide computer-implemented services in the updated operating state.

Thus, embodiments disclosed herein may address, among other technical problems, the technical challenge of hedging against a risk of an undesired outcome from an occurrence of a state (e.g., a set of operational conditions). To hedge against the risk, an action set may be obtained based on a mixed input data set and/or a plurality of predictions generated by at least one inference model. By analyzing the plurality of predictions and/or the mixed input data set using statistical methods, the obtained action set may have an increased likelihood of being tailored to the state. In doing so, resources used to provide computer-implemented services may have an increased likelihood of being appropriately made available and/or distributed, which may result in an increase in a quality and/or reliability of the computer-implemented services.

In an embodiment, a method for managing operation of one or more data processing systems is disclosed. The method may include: obtaining live data, the live data including measurements indicating operational conditions for the one or more data processing systems; obtaining, from external data sources, forecasted data related to the operational conditions, the forecasted data being generated using proprietary methods; performing a sampling process, using the forecasted data, to obtain a mixed input data set, the mixed input data set including the live data and at least a portion of the forecasted data; making a determination, based on at least the mixed input data set, regarding whether a policy of a set of existing policies is invoked, the policy including an action set usable to update operation of the one or more data processing systems; in an instance of the determination in which the policy is invoked: performing the action set to update the operation of the one or more data processing systems; and providing, based on the updated operation of the one or more data processing systems, computer-implemented services.

The measurements may include quantifications of uncertainty and the forecasted data may not include quantifications of uncertainty.

The mixed input data set may include: a first sub-set including a first portion of the forecasted data and the live data; and a second sub-set including a second portion of the forecasted data and the live data.

Performing the sampling process may include randomly selecting the first portion of the forecasted data.

The first portion of the forecasted data may include a first forecasted data value from a first external data source of the external data sources; and the second portion of the forecasted data may include a second forecasted data value from a second external data source of the external data sources, the second forecasted data value representing a same condition at a same point in time as the first forecasted data value.

Making the determination may include: (i) using the first sub-set of the mixed input data set and at least one inference model to obtain a first prediction of a plurality of predictions, and (ii) using the second sub-set of the mixed input data set and the at least one inference model to obtain a second prediction of the plurality of predictions. The plurality of predictions may each indicate whether a future state will occur.

Making the determination may also include: analyzing at least the plurality of predictions to obtain a statistical characterization regarding agreement in the at least the plurality of predictions; making a second determination regarding whether the statistical characterization meets criteria; and in an instance of the second determination in which the statistical characterization meets the criteria: concluding that the policy is invoked.

The statistical characterization may include at least one quantity selected from a group consisting of: (i) a mean, (ii) a median, (iii) a mode, and (iv) a standard deviation.

The method may also include: prior to obtaining the mixed input data set: performing an analysis process using the forecasted data to obtain a forecasted data statistical characterization, the forecasted data statistical characterization indicating variability in forecasted data values of the forecasted data; and using the forecasted data statistical characterization to obtain the mixed input data set so that the mixed input data set may include a representation of the variability in the forecasted data values.

Forecasted data values of the forecasted data may be obtained from the external data sources that may each use different forecasting models and/or different input data for forecasting models with respect to others of the external data sources, and each of the external data sources may provide limited access to information regarding the forecasted data values.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

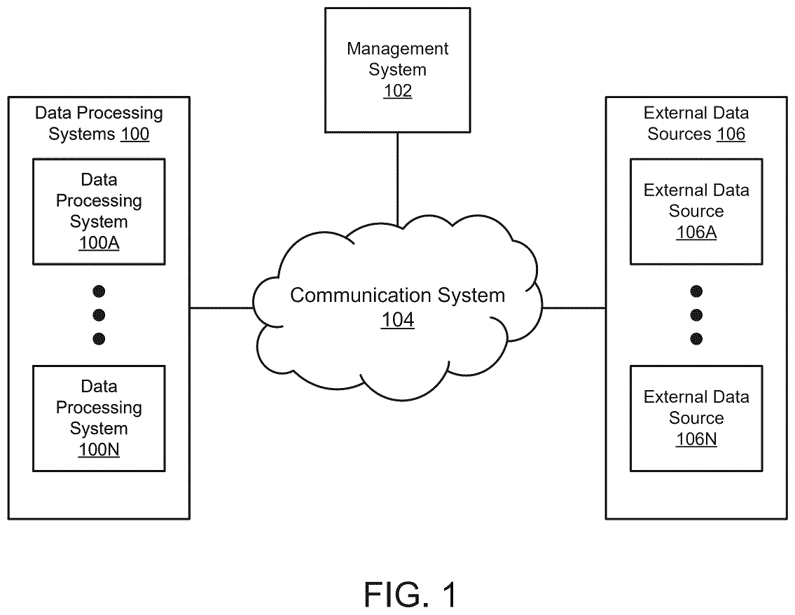

Turning to FIG. 1, a block diagram illustrating a system in accordance with an embodiment is shown. The system shown in FIG. 1 may provide for management of data processing systems that may provide, at least in part, computer-implemented services. The computer-implemented services may include any type and quantity of services including, for example, data services (e.g., data storage, generation, access and/or control services), communication services (e.g., instant messaging services, video-conferencing services), and/or any other type of service that may be implemented with a computing device. The computer-implemented services may be provided by, for example, data processing systems 100, management system 102, external data sources 106, and/or any other type of devices (not shown in FIG. 1). Other types of computer-implemented services may be provided by the system shown in FIG. 1 without departing from embodiments disclosed herein.

The system may include any number and/or type of data processing systems 100 (e.g., 100A-100N). Data processing systems 100 may include any number of hardware components (e.g., processors, memory modules, storage devices, communications devices). The hardware components may support execution of any number and type of applications (e.g., software components). Changes in available functionalities of the hardware and/or software components may provide for various types of different computer-implemented services to be provided over time.

To provide the computer-implemented services, a predetermined quantity of hardware and/or software resources may be used. For example, data processing systems 100 may include robotic entities such as unmanned aerial vehicles (e.g., drones) used to provide agriculture management services. To provide the agriculture management services, the drones may be deployed to various portions of a field used to produce crops in order to spray the portions of the field with pesticide. In order to ensure a desired coverage of the field with pesticide, a certain number of drones may be required.

The provision of the computer-implemented services by data processing systems 100 may be managed by, for example, management system 102. Management system 102 may host at least one inference model used to generate predictions regarding occurrences of future states which may impact the provision of the computer-implemented services. The at least one inference model may ingest live data (e.g., performance data of the data processing systems, sensor data collected by the data processing systems, observational weather data collected by doppler radar, radiosondes, weather satellites, buoys, etc.) to generate the predictions. At least a portion of the conditions of the future states may be interpreted as types of events (e.g., weather events and/or other events which may impact the operation of data processing systems 100).

Returning to the above example, management system 102 may host at least one inference model used to generate a plurality of predictions regarding states (e.g., operational conditions such as weather conditions) which may impact the ability of the drones to provide the agriculture management services. For example, the at least one inference model may generate predictions regarding a likelihood that an impending thunderstorm may damage at least a portion of the drones, resulting in undesired outcomes, such as an inability of the drones to spray the pesticide.

To manage the operation of the one or more data processing systems, management system 102 may utilize any number of policies. The live data (e.g., including measurements that indicate operational conditions for the one or more data processing systems) and/or the plurality of predictions may be keyed to policies of a set of existing policies. Each of the set of existing policies may include an action set usable to update operation of the one or more data processing systems.

However, a quality and/or reliability of the computer-implemented services provided by data processing systems 100 may rely on a likelihood of identifying relevant policies as operational conditions change. The likelihood of identifying the relevant policies may be impacted by a quality of the data (e.g., the live data) used during prediction generation and/or policy selection. Consequently, expanding a range of data sources from which the data are obtained may positively impact prediction generation and/or policy selection.

For example, the at least one inference model may predict that a thunderstorm is unlikely to affect the ability of the drones to perform the agriculture management services and, therefore, operation of the drones may not be updated. If the prediction is inaccurate (e.g., a portion of the drones are unable to spray pesticide as a result of the thunderstorm), the computer-implemented agriculture management services may be of a reduced quality, interrupted, and/or delayed.

In general, embodiments disclosed herein may provide methods, systems, and/or devices for managing operation of one or more data processing systems in a manner that may increase a likelihood that computer-implemented services are provided by the one or more data processing systems as desired by a downstream consumer. To do so, forecasted data may be obtained from external data sources and used along with the live data to obtain mixed input data sets. The live data may include measurements indicating operational conditions for the one or more data processing systems (e.g., sensor data collected from any number of data collectors and/or the one or more data processing systems themselves). The forecasted data may include predictions related to the operational conditions for the one or more data processing systems and may be generated by the external data sources using proprietary methods.

The external data sources may each use different forecasting models and/or different input data for forecasting models with respect to others of the external data sources, and each of the external data sources may provide limited access to information regarding the forecasted data values. Consequently, the forecasted data may not include quantifications of uncertainty in the forecasted data values. The live data, however, may include quantifications of uncertainty in the measurements of the live data that are available. Quantifications of uncertainty may represent degrees of variability in the data values and/or measurements (e.g., due to instrumentation limitations, due to data processing methods and/or other sources of uncertainty).

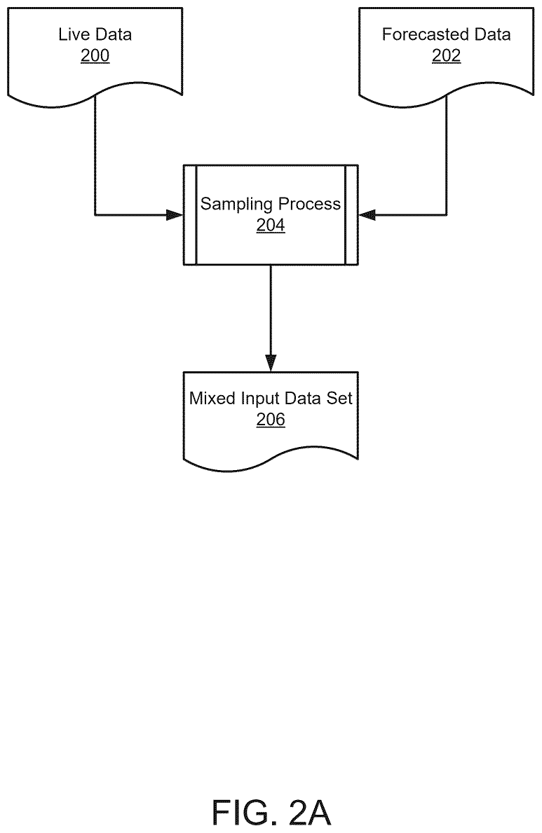

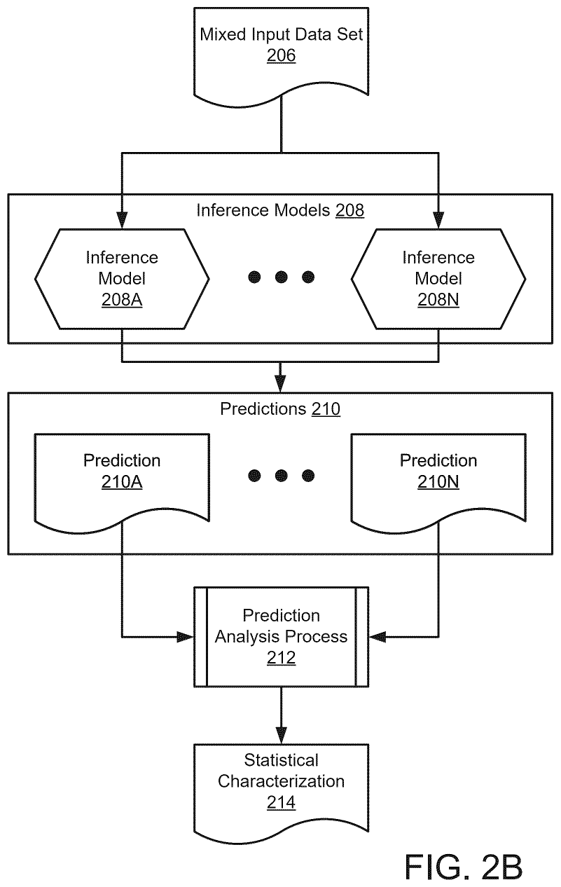

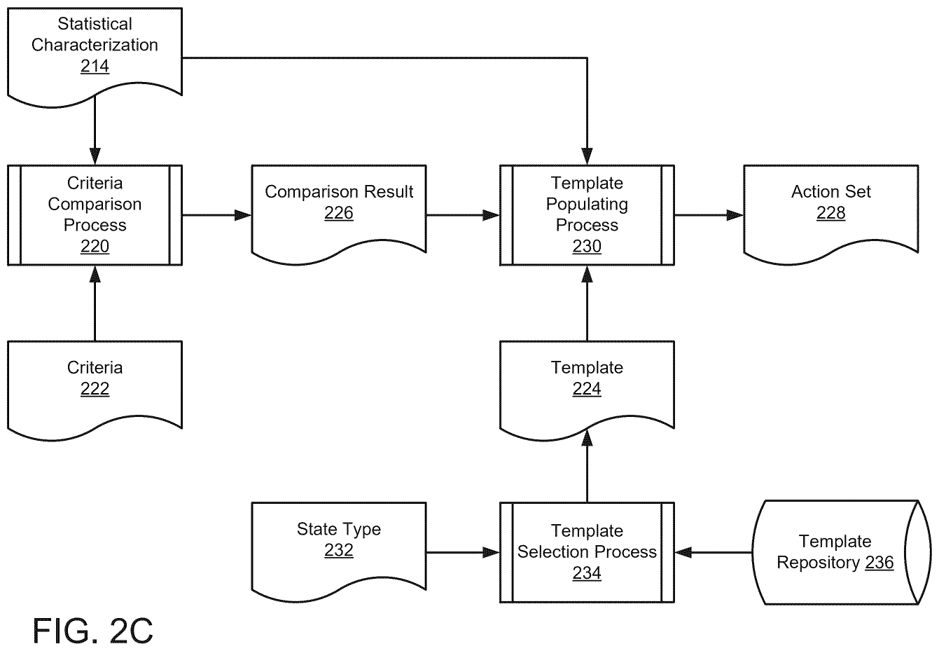

The live data and the forecasted data may be used to generate a mixed input data set and the mixed input data set may be used to generate predictions (e.g., inferences and/or simulations generated by at least one inference model) and/or to select policies from a set of existing policies. To generate the mixed input data set, a sampling process may be performed. During the sampling process, the live data and at least a portion of the forecasted data may be added to the mixed input data set. By sampling and/or analyzing the forecasted data, a representation of variability in the forecasted data may be included in the mixed input data set. Refer to FIG. 2A for additional information regarding obtaining mixed input data sets.

The mixed input data set may be used to generate a plurality of predictions (e.g., inferences, simulations) and the mixed input data set and/or the plurality of predictions may be used to determine whether a policy is invoked. The policy may be invoked if at least a portion of the mixed input data set and/or the plurality of predictions is keyed to the policy.

If the policy is invoked, an action set obtained from the policy may be performed to update the operation of data processing systems 100. By doing so, a system in accordance with an embodiment may be used to obtain action sets for mitigating (potentially negative) effects of a future state using a mixed input data set. The plurality of predictions and/or portions of the mixed input data set may be statistically analyzed to determine whether the future state is predicted to occur and to obtain a corresponding level of uncertainty.

Taking into account statistical characterizations of the plurality of predictions and/or portions of the mixed input data set may increase a likelihood of reliably predicting whether the future state will occur, which may result in generating and performing action sets more likely to hedge against undesired outcomes of the future state. In doing so, computing resources required to provide computer-implemented services may be more likely to be made available and/or deployed where needed, which may increase a quality and/or reliability of the provision of the computer-implemented services.

To perform the above-noted functionality, the system of FIG. 1 may include data processing systems 100, management system 102, and/or external data sources 106. Data processing systems 100, management system 102, external data sources 106, and/or any other type of device not shown in FIG. 1 may perform all, or a portion of, the computer-implemented services independently and/or cooperatively. Each of these components is discussed below.

Data processing systems 100 may include any number and/or type of data processing systems (e.g., 100A-100N), which may include any number of hardware and/or software components configured to provide computer-implemented services. While providing the computer-implemented services, data processing systems 100 may generate data, such as telemetry data, performance data, sensor data, and/or other data related to operation of data processing systems 100. The data generated by data processing systems 100 may be provided to management system 102, which may provide device management services for data processing systems 100.

External data sources 106 may include any number and/or type of devices (e.g., 106A-106N), which may include other data processing systems, servers, storage devices, user devices and/or other devices managed by third-party entities. External data sources 106 may: (i) obtain input data usable to generate forecasted data, (ii) train, host, and/or operate any number of forecasting models usable to predict occurrences of future states based on the input data, and/or (iii) perform other actions. External data sources 106 may provide limited access to information regarding types of forecasting models used to generate the forecasted data, sources of input data used to generate the forecasted data, and/or other information regarding proprietary methods used by external data sources 106. External data sources 106 may provide, for example, weather prediction services that generate publicly available weather forecasts. External data sources 106 may make forecasted data available via publication to publicly accessible sources (e.g., websites, data repositories) and/or may provide the forecasted data to other entities upon request.

Management system 102 may include any number and/or type of devices (e.g., other data processing systems, servers, storage devices, user devices) that may be used to provide the device management services (e.g., data processing system management services). As part of providing the device management services, management system 102 may train and/or host any number and/or type of inference models trained to generate inferences (e.g., predictions, simulations of future states based on data regarding a current state). Data provided to management system 102 by data processing systems 100 may include training data usable to train inference models managed by management system 102 and/or live data usable as ingest for inference models managed by management system 102.

To perform its functionality, management system 102 may (i) obtain live data (e.g., from data processing systems 100, from other data sources), (ii) process the data (e.g., fill data gaps, transform the data, extract values from the data), (iii) use training data to train any number of inference models, (iv) obtain forecasted data from any number of external data sources, (v) perform a sampling process, using the forecasted data, to obtain a mixed input data set (e.g., including the live data and at least a portion of the forecasted data), and/or (vi) determine, based on at least the mixed input data set, whether a policy of a set of existing policies is invoked. If the policy is invoked, management system 102 may perform, at least in part, an action set included in the policy to update the operation of the one or more data processing systems and/or perform other actions.

Performing the sampling process may include randomly selecting the at least the portion of the forecasted data. Refer to FIG. 2A for additional details regarding obtaining the mixed input data set.

Determining whether the policy is invoked may include: (i) generating predictions (e.g. using the mixed input data set), (ii) analyzing the predictions and/or the forecasted data (e.g., using statistical methods) to obtain statistical characterizations of the predictions and/or the forecasted data, (iii) comparing quantities of the statistical characterizations to requirements included in criteria, (iv) determining whether the quantities fulfill the requirements, and/or (v) if the quantities fulfill the requirements, concluding that the policy may be invoked. Refer to FIG. 2B for additional details regarding obtaining statistical characterizations and refer to FIG. 2C for additional details regarding policy selection.

Thus, device management services for data processing systems 100 may be provided by management system 102. By doing so, mixed input data sets and/or predictions generated by at least one inference model may be analyzed using various statistical techniques to determine whether there is sufficient agreement in the predictions to indicate that a future state will occur (e.g., by comparing a statistical characterization to criteria). Based on the results of the analysis, an action set may be performed to mitigate potential effects of undesired outcomes from the occurrence of the future state, which may result in computer-implemented services which have a reduced likelihood of being interrupted and/or delayed.

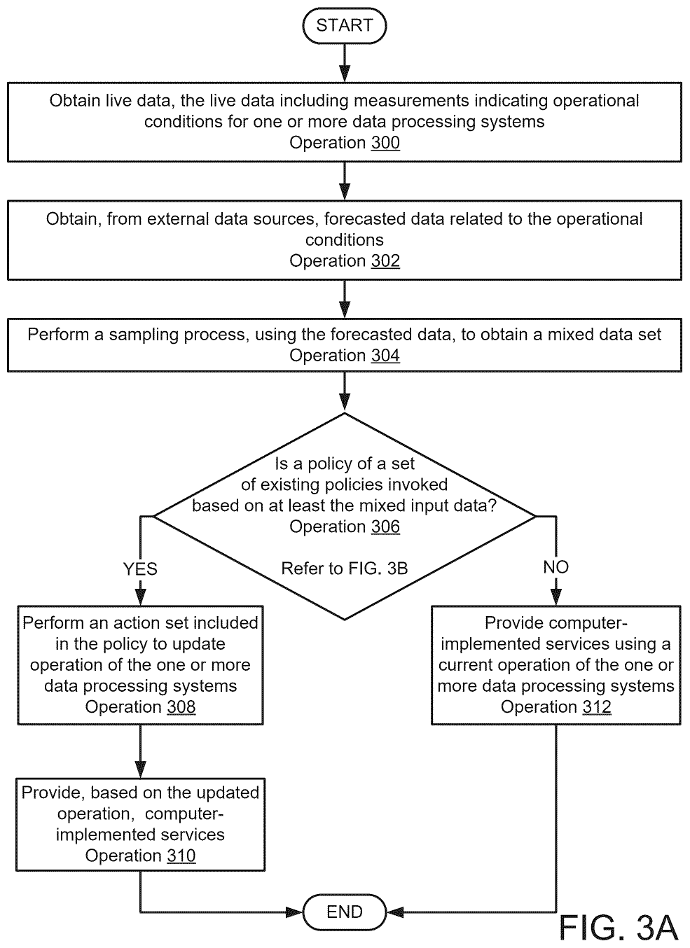

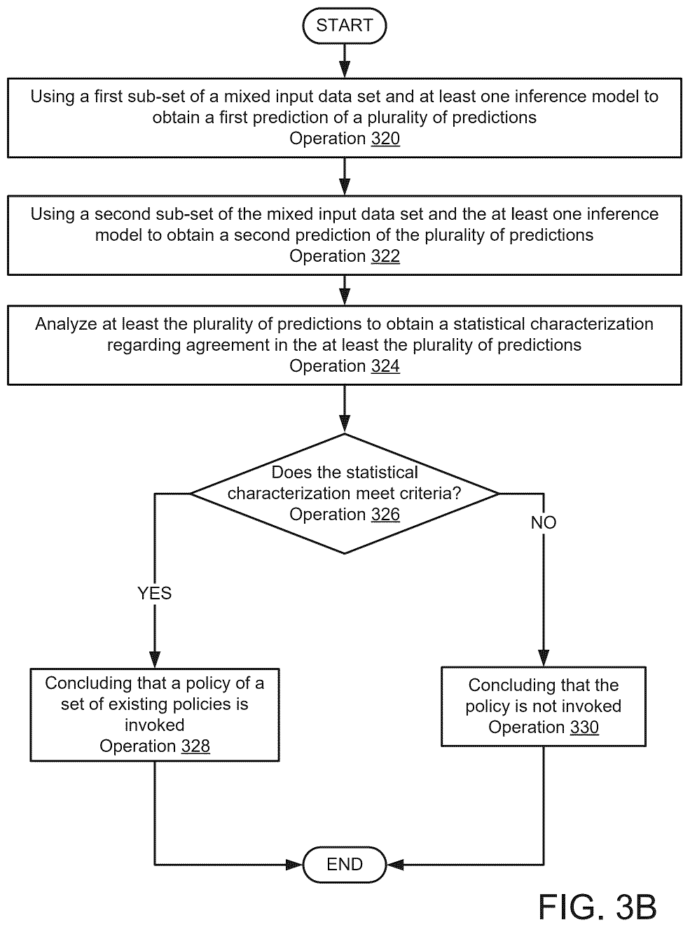

When providing their functionality, any of data processing systems 100, management system 102, and/or external data sources 106 may perform all, or a portion, of the processes, interactions, and methods illustrated in FIGS. 2A-3B.

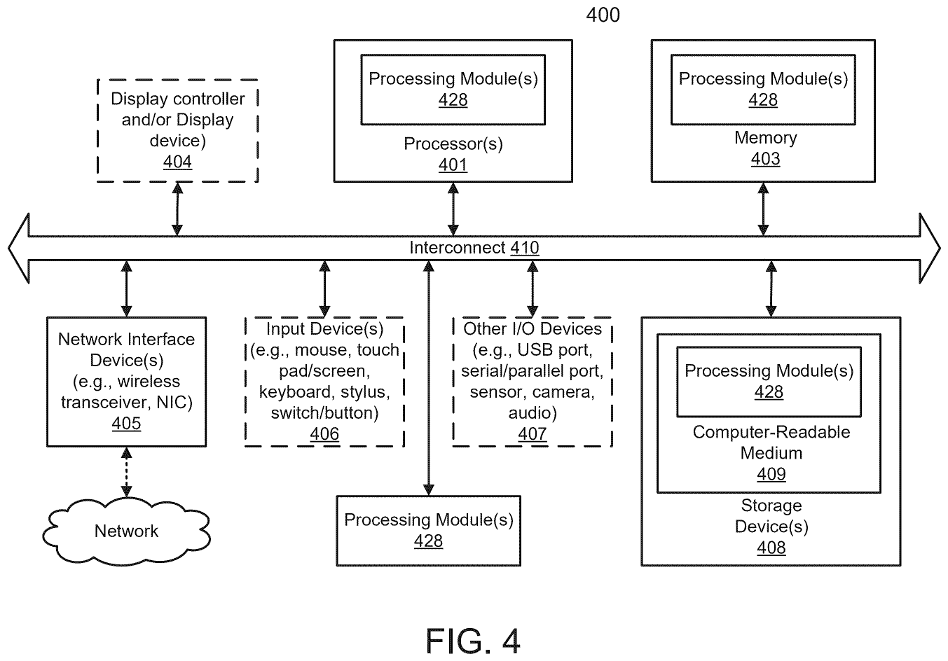

Any of data processing systems 100, management system 102, and/or external data sources 106 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), and edge device, an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 104. Communication system 104 may facilitate communications between the components of FIG. 1. In an embodiment, communication system 104 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein. For example, while the system of FIG. 1 shows a single management system (e.g., 102), it will be appreciated that the system may include any number of management systems.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 200, 202) is used to represent data structures, a second set of shapes (e.g., 204, 212) is used to represent processes performed using and/or that generate data, a third set of shapes (e.g., 236) is used to represent large scale data structures such as databases, and a fourth set of shapes (e.g., 208A) is used to represent inference models.

Turning to FIG. 2A, a first data flow diagram in accordance with an embodiment is shown. The first data flow diagram may illustrate data used in and data processing performed in obtaining a mixed input data set.

To obtain the mixed input data set (e.g., mixed input data set 206), sampling process 204 may be performed using at least live data 200 and forecasted data 202. Live data 200 may include any type and/or quantity of data, including data obtained by data processing systems 100 (e.g., collected using sensors, telemetry data, performance data). Live data 200 may include measurements indicating operational conditions for one or more data processing systems (e.g., data processing systems 100 described in FIG. 1). The operational conditions for the one or more data processing systems may include: (i) environmental conditions in which the one or more data processing systems operate, (ii) system health data for the one or more data processing systems, and/or (iii) other information. Live data 200 may include quantifications of uncertainty in the measurements (e.g., standard deviations) which may be based on sensing limitations of devices used to collect the measurements.

Forecasted data 202 may include any type and/or quantity of data obtained from any number of external data sources (e.g., external data sources 106 described in FIG. 1). The external data sources may include third-party entities and forecasted data 202 may be generated using proprietary methods. For example, forecasted data 202 may include forecasted data values (e.g., predicted values, simulated values) generated by forecasting models operated by the third-party entities. Each of the external data sources (e.g., the third-party entities) may use different types of forecasting models (e.g., inference models, digital twins, models trained using different training data) and/or may use different input data for the forecasting models with respect to others of the external data sources (e.g., different data collectors, different sensors, different data repositories).

In addition, each of the external data sources may provide limited access to information regarding the forecasted data values due to the proprietary methods (e.g., proprietary logic, such as algorithms, code, concepts, etc.) used to generate the forecasted data values. The external data sources may wish to protect and/or otherwise restrict access to the proprietary methods. Consequently, forecasted data 202 may be obtained (e.g., from publicly available sources such as websites) without obtaining quantifications of uncertainty (e.g., standard deviations for measurements, confidence levels for predictions) and/or other information from the external data sources usable to understand a level of confidence in the forecasted data values.

For example, forecasted data 202 may include at least a first portion and a second portion. The first portion of forecasted data 202 may include a first forecasted data value (e.g., a predicted temperature) from a first external data source of external data sources 106. The second portion of forecasted data 202 may include a second forecasted data value (e.g., a second predicted temperature) from a second external data source of external data sources 106. The second forecasted data value may represent a same condition at a same point in time as the first forecasted data point. The same condition may be, for example, a temperature measurement for a geographical location at 8:00 AM the following day. Therefore, the first forecasted data value and the second forecasted data value may be members of a first sub-set of corresponding forecasted data values of forecasted data 202.

Due to the proprietary methods used to generate the forecasted data values (e.g., different types of forecasting models, different input data for the forecasting models, different training data for the forecasting models, different forecasting methods), corresponding forecasted data values of forecasted data 202 may include a degree of variability. For example, the first forecasted data value may indicate that the temperature at 8:00 AM the following day is predicted to be 29° C. and the second forecasted data value may indicate that the temperature at 8:00 AM the following day is predicted to be 31° C. Forecasted data 202 may include any number of sub-sets of corresponding forecasted data values (e.g., forecasted data values indicating a same condition at a same point in time) for any number of conditions and/or any number of points in time).

During sampling process 204, any number of sub-sets of mixed input data set 206 may be generated and each sub-set of the any number of sub-sets of mixed input data set 206 may include live data 200 and at least a portion of forecasted data 202. The first forecasted data value may be selected (e.g., via random selection) and added to a first sub-set of the sub-sets along with live data 200. The second forecasted data value may be selected (e.g., via random selection) and added to a second sub-set of the sub-sets along with live data 200. By doing so, mixed input data set 206 may include any number of sub-sets and each sub-set of the sub-sets of mixed input data set 206 may include measurements of live data 200 and at least a portion of forecasted data 202.

By doing so, variability among corresponding forecasted data values of forecasted data 202 may be represented in mixed input data set 206. Sampling process 204 may be performed, for example, so that an inference model may ingest each sub-set of mixed input data set 206 during separate prediction (e.g., inference) generation processes (not shown). A plurality of predictions generated by the inference model may be analyzed in aggregate thereby reducing a likelihood that the forecasted data values adversely impact a reliability and/or quality of decisions made based on the plurality of predictions. While described above with respect to one inference model, it may be appreciated that each sub-set of mixed input data set 206 may be fed into each of a plurality of inference models without departing from embodiments disclosed herein.

During and/or prior to sampling process 204, an analysis process may also be performed using forecasted data 202 to obtain a forecasted data statistical characterization (not shown). The forecasted data statistical characterization may indicate variability in forecasted data values of forecasted data 202. The forecasted data statistical characterization may be obtained using any type and/or quantity of statistical methods (e.g., techniques, calculations, data fitting), including averaging, population distribution calculations, hypothesis testing, regression, analysis of variance, and/or any other type of statistical methods. The forecasted data statistical characterization may include any number of means, medians, modes, and/or standard deviations for sub-sets of corresponding forecasted data values of forecasted data 202.

The forecasted data statistical characterization may be used during sampling process 204 so that mixed input data set 206 may include a representation of the variability in the forecasted data values. The forecasted data statistical characterization may include, as previously mentioned, a standard deviation of the corresponding forecasted data values in aggregate. The standard deviation may, therefore, be appended to a portion of mixed input data set 206, may be included in a mathematical operation intended to represent uncertainty throughout mixed input data set 206, and/or may be used during sampling process 204 via other methods.

Thus, by implementing the data flow shown in FIG. 2A, a system in accordance with embodiments disclosed herein may be used to obtain a mixed input data set usable to characterize operational conditions for one or more data processing systems. By utilizing forecasted data values from external data sources, input data sets may be expanded with information from a wider range of sources, which may increase a likelihood of accurately characterizing operating conditions for the one or more data processing systems. Therefore, the mixed input data sets may be usable to generate predictions (e.g., by an inference model) and/or may be used to identify relevant policies usable to manage operation of the one or more data processing systems.

Turning to FIG. 2B, a second data flow diagram in accordance with an embodiment is shown. The second data flow diagram may illustrate data used in and data processing performed in obtaining a statistical characterization using a plurality of predictions generated using at least one inference model.

To obtain the statistical characterization, mixed input data set 206 may be used as ingest to generate predictions using at least one inference model (e.g., inference models 208). Inference models 208 may be hosted by a management system (e.g., management system 102, not shown) responsible for managing operation of data processing systems used to provide computer-implemented services (e.g., data processing systems 100, not shown).

Mixed input data set 206 may be provided to inference models 208 and used as ingest to generate predictions. Inference models 208 may include a single inference model (e.g., 208A) or plurality of inference models (e.g., 208A-208N) and inference models 208 may include any type of inference model. For example, inference models 208 may include machine learning models (e.g., decision tree, quantile regression) and/or simulation models (e.g., deterministic simulation, computationally-driven simulation, dynamic simulation, analytical simulation). Inference models 208 may be trained using training data which defines goals for predictions made by the inference models. Parameters of the inference models may be selected using an optimization process (e.g., an objective function may be defined in terms of the training data and predictions made by the inference models, and a global optimization method such as gradient descent may be used to identify parameters that most faithfully reproduce the trends in the training data). Once the parameters of an inference model (e.g., inference model 208A) are set, then the inference model may be used to make predictions. Differences in model type, training data, and/or the optimization process may result in variability between the predictions made by the inference models, even when the predictions are generated using the same (and/or substantially the same) input dataset. In addition, the predictions may include stochastic elements (e.g., random variance in one or more parameters over time) which may result in prediction variability. Prediction variability may reduce a reliability of using the predictions as a basis for making decisions.

The input dataset used as ingest for inference models 208 (e.g., mixed input data set 206) to generate predictions may be substantially the same for inference models 208. For example, a substantially the same input dataset may include criteria which permit up to a 10% difference in the input data set (e.g., at least 90% of the input data set is the same). In a second example, the criteria may indicate that the input dataset may only differ by 5% to be considered substantially the same (e.g., at least 95% of the input dataset is the same). In a third example, the criteria may indicate that the input dataset may differ by 25% to be considered substantially the same (e.g., at least 75% of the input dataset is the same).

As described in FIG. 2A, mixed input data set 206 may include any number of sub-sets. During generation of predictions 210 using inference models 208, each sub-set of the sub-sets of mixed input data set 206 may be fed into each inference model of inference models 208. Therefore, if inference models 208 includes a single inference model (e.g., 208A), predictions 210 may include a plurality of predictions generated using respective sub-sets of mixed input data set 206.

Predictions 210 may include a plurality of predictions (e.g., 210A-210N) generated by at least one inference model that each indicate whether a state will occur in a future (e.g., at any future point in time, over a duration of time beginning at any future point in time). At least a portion of the state may be interpreted as an event (e.g., a sandstorm, wind, a temperature increase). For example, predictions 210 may include predictions regarding states which may impact the operation of data processing systems 100, such as changes in temperature, resource availability (e.g., forecasted changes in power supply and/or demand), weather conditions (e.g., rain, hail, wind), and/or any other events which may impact the devices.

For example, data processing systems 100 may include edge devices managed by management system 102, which may include smart streetlights. The smart streetlights may be implemented to conserve power by adjusting the amount of light generated based on data collected by sensors. The data collected by the sensors may include data regarding brightness, humidity, motion, temperature, etc. Forecasted weather data may also be obtained from any number of external weather reporting services. The sensor data (e.g., live data) and forecasted weather data may be provided to management system 102 and used, at least in part, as input data for at least one inference model used to generate predictions regarding occurrences of states (e.g., portions of which may be interpreted as events such as thunderstorms) which may impact the operation of the smart streetlights.

The plurality of predictions (e.g., predictions 210A-210N) may be used to perform prediction analysis process 212. During prediction analysis process 212, predictions 210 may be analyzed in aggregate to obtain a statistical characterization (e.g., statistical characterization 214) regarding agreement in the plurality of predictions. The statistical characterization may be obtained using any type and/or quantity of statistical methods (e.g., techniques, calculations, data fitting), including averaging, population distribution calculations, hypothesis testing, regression, analysis of variance, and/or any other type of statistical methods. Statistical characterization 214 may include a mean, median, mode, and/or standard deviation for predictions 210.

Continuing with the above example, the at least one inference model may generate predictions based on the mixed input data regarding an increase in temperature which may affect operation of 100 smart streetlights (e.g., the operation may be impacted to an undesirable degree if the operation continues in the current operating state). For example, the mixed input data (e.g., including temperature data collected by the sensors, temperature data collected from weather satellites, and/or temperature predictions extracted from weather forecasting websites) may be used as input data for 20 inference models. Of the 20 inference models, 5 may generate predictions indicating the temperature will affect operation of 60 smart streetlights, 10 may generate predictions indicting the temperature will affect operation of 80 smart streetlights, 3 may generate predictions indicating the temperature will affect operation of 75 smart streetlights, and 2 may generate predictions indicting the temperature will affect operation of 10 smart streetlights.

A prediction analysis process may be used to analyze the predictions using statistical methods to obtain statistical characterizations including a median (e.g., 77.5 smart streetlights will be affected) and a standard deviation (e.g., 21.3 smart streetlights).

Thus, by implementing the data flow shown in FIG. 2B, a system in accordance with embodiments disclosed herein may be used to obtain a statistical characterization of a plurality of predictions generated by at least one inference model that represents variability within the plurality of predictions.

Turning to FIG. 2C, a third data flow diagram in accordance with an embodiment is shown. The third data flow diagram may illustrate data used in and data processing performed in identifying whether a policy of a set of existing policies is invoked and, if the policy is invoked, generating an action set based on at least a statistical characterization obtained via the analysis of the plurality of predictions shown in FIG. 2B.

To determine whether the policy is invoked, criteria comparison process 220 may be performed. To perform criteria comparison process 220, statistical characterization 214 may be compared to criteria (e.g., criteria 222) to determine whether statistical characterization 214 meets criteria 222 (e.g., comparison result 226). Making the determination may include (i) identifying at least one quantity of statistical characterization 214, (ii) identifying a requirement indicated by criteria 222 that corresponds to the at least one quantity, (iii) analyzing the at least one quantity using the requirement to obtain at least a partial result indicating whether statistical characterization 214 meets criteria 222, and/or (iv) other methods. The at least one quantity may include a numerical value and/or other types of metrics calculated using a statistical method (e.g., a mean, median, mode, standard deviation) used to quantify a level of agreement between the plurality of predictions.

Criteria 222 may include requirements corresponding to quantities of statistical characterization 214 that if met, may indicate that the policy is invoked. For example, the requirements may include a first requirement for a median of the plurality of predictions falling within a first range, and a second requirement for a standard deviation of the plurality of predictions falling within a second range. When the median falls within the first range, the plurality of predictions may indicate that the state is predicted to occur, and when the standard deviation falls within the second range, then the plurality of predictions may indicate that the occurrence of the state has a level of uncertainty falling within an acceptable range (e.g., the state is predicted to occur). In this example, the median and/or the standard deviation falling outside of their respective ranges may indicate that statistical characterization 214 does not meet criteria 222 (e.g., the state is not predicted to occur). Different types of states, affected devices, and/or other characteristics related to the predictions may result in differences in the requirements included in criteria 222.

For example, if the state is predicted to occur with a level of uncertainty that falls within the acceptable range, a first policy may be invoked and if the state is predicted to occur with a level of uncertainty that does not fall within the acceptable range but falls within a second range (e.g., included in criteria 222 and/or other criteria), a second policy may be invoked.

Returning to the smart streetlights example, the statistical characterization of the plurality of predictions regarding the number of smart streetlights that may be affected by a future temperature increase may include a median of 77.5 and a standard deviation of 21.3. Criteria for the statistical characterization may include a first range corresponding to the median (e.g., 70-100) and a second range corresponding to the standard deviation (e.g., 0-25). It may be determined that the median and the standard deviation fall within their respective ranges, and thus the statistical characterization may meet the criteria.

If comparison result 226 indicates that statistical characterization 214 meets criteria 222 and therefore the policy is invoked, template populating process 230 may be performed to obtain action set 228. Action set 228 may be based on the occurrence of the state predicted by the plurality of predictions to occur and usable to update an operating state of a data processing system (e.g., predicted to be affected by the state) to hedge against a risk of an undesired outcome from the occurrence of the state.

To obtain action set 228, template selection process 234 may be performed. During template selection process 234, a template (e.g., template 224) may be selected from a repository of templates (e.g., template repository 236). Template repository 236 may include any number of templates keyed to different types of states. For example, template 224 may be selected based on a type of the state (e.g., precipitation, temperature increase/decrease, power shortage) that is predicted by the plurality of predictions to occur (e.g., state type 232) and to which template 224 is keyed in template repository 236. State type 232 may be generated as part of the prediction generation process (e.g., may be included in predictions 210 in FIG. 2B, may be appended to statistical characterization 214).

Template 224 may include sets of prototype actions which may be keyed, at least in part, to the quantity of statistical characterization 214. During template populating process 230, template 224 may be populated using at least one quantity of statistical characterization 214 in order to dynamically generate action set 228. Dynamically generating action set 228 may include selecting actions from the sets of prototype actions included in the populated template.

For example, template 224 may include a schema used to assign levels of impact (e.g., on the data processing systems) of undesired outcomes due to the occurrence of the state. The levels of impact may be keyed to statistical characterizations for the type of state. For example, a first range of median values indicating a number of devices affected by the state may correspond to a first level of impact, and a second range of median values may correspond to a second level of impact, with the second level of impact being higher than the first level of impact. Prototype actions may be selected from template 224 based on the assigned level of impact. Prototype actions may include a list of actions associated with different levels of impact if the state occurred, such as reducing power consumption of data processing systems, powering off data processing systems, moving data processing systems to a different location, etc.

Continuing with the above example, a template may be selected from a repository of templates (e.g., by performing a lookup) based on a type of the predicted state (e.g., a temperature increase). The template may be populated with the median number of smart streetlights predicted to be affected by the temperature increase (e.g., 77.5), and the populated template may indicate a second level of impact if the state occurred (e.g., an increased likelihood of significant damage to the smart streetlights). The second level of impact may be used to generate an action set by retaining actions of the prototype actions which correspond to the second level of impact to hedge against the risk of damage to the smart streetlights. Actions of the prototype actions that do not correspond to the second level of impact may be removed from the action set. The selected actions used to generate the action set may include powering off the smart streetlights to decrease the risk of damage due to operation in high temperatures. While described with respect to retaining and/or removing actions of the prototype actions included in the template, any number of additional actions (e.g., from an action set repository) not included in the template may be added to the action set (e.g., based on input from a subject matter expert).

Therefore, template 224 may be customized, at least in part, based on levels of uncertainty of the occurrence of the state indicated by statistical characterization 214 (e.g., the standard deviation of the predictions, other metrics of uncertainty). Customizing template 224 may include retaining or removing prototype actions during population of the template based on the levels of uncertainty. For example, populating template 224 with a high uncertainty value (e.g., based on ranges of uncertainty values that are assigned corresponding labels such as “high” or “low”) for the predicted state may result in the removal of a prototype action, such as powering off the data processing systems, from template 224 in order to hedge against the uncertainty that the state will occur.

Continuing with the above example, the standard deviation of the predictions may be calculated to be 21.3 and, therefore, may fall within a range indicated by a requirement of criteria 222. If the standard deviation falls within the range indicated by a requirement of the criteria, the standard deviation may be considered high relative to other statistical metrics (e.g., the mean, the median), and thus may indicate a high level of uncertainty in the predictions (e.g., based on labels associated with ranges of standard deviations indicated by criteria 222). The standard deviation may be used to customize the template based on the high level of uncertainty in the predictions by removing prototype actions from the template used to generate an action set.

For example, based on the median of the plurality of predictions, the template may indicate that the smart streetlights are to be powered off. However, powering off the smart streetlights may also result in undesired outcomes, such as unsafe driving and/or walking conditions due to reduced lighting of roads and sidewalks. To hedge against the high uncertainty that the increase in temperature resulting in damage to the smart streetlights will occur, the prototype action of powering off the smart streetlights may be removed from the template. In doing so, other prototype actions from the template may be selected, and/or alternative actions may be selected from an action set repository (not shown). For example, an alternative action such as decreasing the power consumption of the smart streetlights may be selected, and used to generate an action set.

Once template 224 has been customized using statistical characterization 214, action set 228 may be generated. Generating action set 228 may include selecting actions based on template 224 to update an operating state of a data processing system. Action set 228 may be provided to the data processing systems (e.g., via transmission in a message) and performed by updating the operating state of the data processing system to an updated operating state. Computer-implemented services may then be provided using the data processing systems in the updated operating state.

Continuing with the above example, an action set for updating operation of the smart streetlights may be generated based on the customized template. The action set may include reducing the power consumption of the smart streetlights by 50%. By performing the action set, there may be a reduced risk of damage to the smart streetlights, while continuing to provide computer-implemented lighting services.

Thus, by implementing the data flow shown in FIG. 2C, a system in accordance with embodiments disclosed herein may increase the likelihood of generating an action set to update an operating state of data processing systems based on operational conditions for the data processing systems. The updated operating state may reduce an impact of an undesired outcome from the occurrence of a state predicted to occur by at least one inference model.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1-2C may perform various methods to manage inference models. FIGS. 3A-3B illustrate methods that may be performed by the components of the system of FIGS. 1-2C. In the diagram discussed below and shown in FIGS. 3A-3B, any of the operations may be repeated, performed in different orders, and/or performed in parallel with or in a partially overlapping in time manner with other operations.

Turning to FIG. 3A, a first flow diagram illustrating a method of managing inference models in accordance with an embodiment is shown. The method may be performed, for example, by any of the components of the system of FIG. 1, and/or any other entity without departing from embodiments disclosed herein.

At operation 300, live data may be obtained. The live data may include measurements indicating operational conditions for one or more data processing systems. Obtaining the live data may include: (i) reading the live data from storage, (ii) receiving the live data from another entity (e.g., the one or more data processing systems, data collectors, sensors), and/or (iii) other methods.

At operation 302, forecasted data may be obtained from external data sources. The forecasted data may be related to the operational conditions for the one or more data processing systems. Obtaining the forecasted data may include: (i) reading the forecasted data from storage, (ii) extracting the forecasted data from any number of publicly accessible data sources (e.g., websites, data repositories), (iii) receiving the forecasted data from another entity (e.g., in the form of a message over a communication system, and/or (iv) other methods.

At operation 304, a sampling process may be performed, using the forecasted data, to obtain a mixed input data set. Performing the sampling process may include: (i) randomly selecting a first portion of the forecasted data, (ii) adding the first portion of the forecasted data to the mixed input data set, and/or (iii) other methods.

Randomly selecting the first portion of the forecasted data may include at least a portion of any statistical sampling methodology including: (i) simple random sampling, (ii) systematic random sampling, (iii) cluster random sampling, (iv) stratified random sampling, and/or (v) other methodologies. In addition, randomly selecting the first portion may include: (i) bootstrapping, (ii) permutation generation, (iii) cross-validation and/or (iv) other statistical sampling techniques usable to select the first portion of the forecasted data.

For example, randomly sampling the forecasted data may include: (i) obtaining the first portion of the forecasted data (e.g., at least one forecasted data value from a first external data source) via any random sampling technique, (ii) adding the first portion to a first sub-set of the mixed input data set, (iii) obtaining a second portion of the forecasted data (e.g., at least one forecasted data value indicating a same condition at a same point in time as the first portion and from a second external data source) via any random sampling technique, (iv) adding the second portion to a second sub-set of the mixed input data set, (v) adding the live data to the first sub-set and the second sub-set, and/or (vi) generating any number of additional sub-sets of the mixed input data set using methods similar to those described above with respect to the first sub-set and the second sub-set.

Consequently, the mixed input data set may include any number of sub-sets. Each sub-set of the sub-sets of the mixed input data set may include at least: (i) all or a portion of the live data, (ii) a random sampling of the forecasted data values, and/or (iii) other information (e.g., statistical characterizations of any portion of the live data and/or forecasted data values).

For example, prior to obtaining the mixed input data set, an analysis process may be performed using the forecasted data to obtain a forecasted data statistical characterization. The forecasted data statistical characterization may indicate variability in corresponding forecasted data values and/or other groupings of forecasted data values. Performing the analysis process may include: (i) aggregating at least a portion of the forecasted data values into a dataset, (ii) using statistical methods to obtain the forecasted data statistical characterization of the dataset, (iii) proving the dataset to another device and receiving the forecasted data statistical characterization in response, and/or (iv) other methods.

Using statistical methods may include performing statistical calculations (e.g., averaging, population distribution calculations, hypothesis testing, regression, analysis of variance) to obtain the forecasted data statistical characterization. The forecasted data statistical characterization may include a mean, median, mode, standard deviation and/or any other type of statistical characterization of the dataset usable to represent variability in the forecasted data values.

The forecasted data statistical characterization may be used to obtain the mixed input data set so that the mixed input data set includes a representation of the variability in the forecasted data values. Using the forecasted data statistical characterization to obtain the mixed input data value may include: (i) appending the forecasted data statistical characterization to the mixed input data set, (ii) calculating one or more synthetic data values using the forecasted data statistical characterization, (iii) providing the forecasted data statistical characterization to another entity responsible for generating the mixed input data set, and/or (iv) other methods.

Obtaining the mixed input data set may, therefore, include: (i) reading the mixed input data set from storage, (ii) receiving the mixed input data set from another entity responsible for generating the mixed input data set, (iii) generating the mixed input data set (e.g., via methods described above with respect to populating sub-sets of the mixed input data set), and/or (iv) other methods.

At operation 306, it may be determined whether a policy of a set of existing policies is invoked based on at least the mixed input data. Determining whether the policy is invoked may include: (i) using the first sub-set of the mixed input data and at least one inference model to obtain a first prediction of a plurality of predictions, (ii) using the second sub-set of the mixed input data set and the at least one inference model to obtain a second prediction of the plurality of predictions, (iii) analyzing at least the plurality of predictions to obtain a statistical characterization regarding agreement in the at least the plurality of predictions, (iv) determining whether the statistical characterization meets criteria, and/or (v) if the statistical characterization meets the criteria, concluding that the policy is invoked. Refer to FIG. 3B for additional details regarding determining whether the policy is invoked.

If the policy is invoked, the method may proceed to operation 308. At operation 308, an action set included in the policy may be performed to update operation of the one or more data processing systems. Performing the action set may include: (i) obtaining the action set, (ii) transmitting instructions to the one or more data processing systems (e.g., via a message), the instructions indicating the actions to be performed based on the action set, (iii) parsing the instructions, (iv) executing the instructions to update the operating state of the one or more data processing systems to an updated operating state, and/or (v) other methods.

Obtaining the action set may include: (i) selecting, from a repository of templates keyed to types of states, a template based on a type of the state that is predicted by the plurality of predictions to occur, (ii) populating the template using, at least in part, the quantity of the statistical characterization of the plurality of predictions, and/or (iii) other methods.

Selecting the template may include (i) identifying the type of the state that is predicted to occur (e.g., from a list of types of states based on characteristics of the state), (ii) performing a lookup in the repository of templates to identify the template corresponding to the type of state that is predicted to occur, (iii) providing data regarding the state that is predicted to occur to another device and receiving the template in response, and/or (iv) other methods.

Populating the template may include (i) inputting the quantity of the statistical characterization into the template, (ii) dynamically generating the action set based on at least the quantity of the statistical characterization, and/or (iii) other methods.

Dynamically generating the action set may include (i) obtaining a level of uncertainty of the occurrence of the state indicated by the statistical characterization, (ii) customizing the template, at least in part, based on the level of uncertainty of the occurrence of the state indicated by the statistical characterization, and/or (iii) other methods.

Customizing the template may include (i) obtaining second criteria indicating an acceptable level of uncertainty for performing prototype actions included in the template (e.g., as indicated by a schema included in the template), (ii) retaining prototype actions of the action set if the level of uncertainty meets the second criteria, (iii) removing prototype actions of the action set if the level of uncertainty does not meet the second criteria, (iv) selecting actions from an action set repository based on the customized template, and/or (v) other methods.

At operation 310, computer-implemented services may be provided using the one or more data processing systems in the updated operating state. Providing the computer-implemented services in the updated operating state may include (i) initiating performance of functions of the one or more data processing systems in a modified state (e.g., at a reduced power, at a reduced processor frequency), (ii) initiating performance of the functions of the one or more data processing systems in a different location (e.g., in a location where the state is not predicted to occur), (iii) initiating performance of the functions of the one or more data processing systems at a different time (e.g., before and/or after the occurrence of the state), and/or (iv) other methods.

Returning to operation 306, if it is determined that the policy is not invoked (e.g., the determination is “No” at operation 306), then the method may proceed to operation 312.

At operation 312, the computer-implemented services may be provided using the one or more data processing systems in a current operating state. Providing the computer-implemented services in the current operating state may include not modifying the performance of the functions of the one or more data processing systems.

The method may end following operation 312.

Turning to FIG. 3B, a second flow diagram illustrating a method of determining whether a policy is invoked in accordance with an embodiment is shown. The method may be performed, for example, by any of the components of the system of FIG. 1, and/or any other entity without departing from embodiments disclosed herein. The operations described in FIG. 3B may be an expansion of operation 306 in FIG. 3A.

At operation 320, a first sub-set of a mixed input data set and at least one inference model may be used to obtain a first prediction of a plurality of predictions. Using the first sub-set of the mixed input data set and the at least one inference model to obtain the first prediction may include: (i) obtaining the first sub-set, (ii) feeding the first sub-set into the at least one inference model as ingest data, (iii) obtaining, as output from the at least one inference model, the first prediction, and/or (iv) other methods.

At operation 322, a second sub-set of the mixed input data set and the at least one inference model may be used to obtain a second prediction of the plurality of predictions. Using the second sub-set of the mixed input data set and the at least one inference model to obtain the second prediction may include: (i) obtaining the second sub-set, (ii) feeding the second sub-set into the at least one inference model as ingest data, (iii) obtaining, as output from the at least one inference model, the second prediction, and/or (iv) other methods.

At operation 324, at least the plurality of predictions may be analyzed to obtain a statistical characterization regarding agreement in the at least the plurality of predictions. Analyzing the at least the plurality of predictions may include (i) aggregating the plurality of predictions into a dataset, (ii) using statistical methods to obtain the statistical characterization of the dataset, (iii) proving the dataset to another device and receiving the statistical characterization in response, and/or (iv) other methods. Analyzing the at least the plurality of predictions may also include analyzing other quantities such as data values of the mixed input data set, forecasted data value statistical characterizations, etc.

Using statistical methods may include performing statistical calculations (e.g., averaging, population distribution calculations, hypothesis testing, regression, analysis of variance) to obtain the statistical characterization. The statistical characterization may include a mean, median, mode, standard deviation and/or any other type of statistical characterization of the dataset usable to determine agreement in the plurality of predictions.

At operation 326, a determination may be made regarding whether the statistical characterization meets criteria. Making the determination may include (i) identifying at least one quantity of the statistical characterization (e.g., analyzing the statistical characterization to extract a numerical value and/or other type of metric), (ii) identifying a requirement indicated by the criteria that corresponds to the at least one quantity, (iii) analyzing the at least one quantity using the requirement to obtain at least a partial result indicating whether the statistical characterization meets the criteria, and/or (iv) other methods.

Identifying the requirement indicated by the criteria may include (i) parsing the criteria to identify the requirement corresponding to a type of statistical characterization obtained by analyzing the plurality of predictions, (ii) analyzing the requirement to extract a quantity and/or range of quantities indicated by the requirement, (iii) providing the criteria to another device and receiving the requirement in response, and/or (iv) other methods.

Analyzing the at least one quantity using the requirement may include (i) comparing the quantity of the statistical characterization to the quantity and/or range of quantities indicated by the requirement, (ii) determining whether the quantity of the statistical characterization meets and/or exceeds the quantity indicted by the requirement to obtain at least the partial result, (iii) determining whether the quantity of the statistical characterization falls within the range of quantities indicated by the requirement to obtain at least the partial result, (iv) providing the requirement and the quantity of the statistical characterization to another device and receiving at least the partial result in response, and/or (v) other methods.

If it is determined that the statistical characterization meets criteria, (e.g., the determination is “Yes” at operation 326), then the method may proceed to operation 328.

At operation 328, it may be concluded that a policy of a set of existing policies is invoked. Concluding that the policy is invoked may include: (i) providing a notification to another entity indicating that the policy is invoked, (ii) generating a log entry indicating that the policy is invoked and storing the log entry in storage, (iii) initiating performance of an action set included in the policy (e.g., refer to operation 308), and/or (iv) other methods.

The method may end following operation 328.

Returning to operation 326, the method may proceed to operation 330 in an instance of the determination in which the statistical characterization does not meet the criteria.

At operation 330, it may be concluded that the policy is not invoked. Concluding that the policy is not invoked may include: (i) taking no action, (ii) providing a notification to another entity indicating that the policy is not invoked, (iii) generating a log entry indicating that the policy is not invoked and storing the log entry in storage, and/or (iv) other methods. The method may end following operation 330.

Thus, using the methods illustrated in FIGS. 3A-3B, embodiments disclosed herein may provide systems and methods usable to manage operation of data processing systems by statistically analyzing a plurality of predictions generated by at least one inference model and/or a mixed input data set. An action set may be obtained based on the statistical analysis, and the performance of the action set may allow for the provision of computer-implemented services by the data processing systems in an updated operating state. The updated operating state may hedge against a risk of undesired outcomes from a state predicted by the plurality of predictions and/or indicated by the mixed input data set.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of one or more data processing systems, the method comprising:
obtaining live data, the live data comprising measurements indicating operational conditions for the one or more data processing systems;
obtaining, from external data sources, forecasted data related to the operational conditions, the forecasted data being generated using proprietary methods;
performing a sampling process, using the forecasted data, to obtain a mixed input data set, the mixed input data set comprising the live data and at least a portion of the forecasted data;
making a determination, based on at least the mixed input data set, regarding whether a policy of a set of existing policies is invoked, the policy comprising an action set usable to update operation of the one or more data processing systems;
in an instance of the determination in which the policy is invoked:
performing the action set to update the operation of the one or more data processing systems; and
providing, based on the updated operation of the one or more data processing systems, computer-implemented services.

2. The method of claim 1, wherein the measurements comprise quantifications of uncertainty and the forecasted data do not comprise quantifications of uncertainty.

3. The method of claim 1, wherein the mixed input data set comprises:
a first sub-set comprising a first portion of the forecasted data and the live data; and
a second sub-set comprising a second portion of the forecasted data and the live data.

4. The method of claim 3, wherein performing the sampling process comprises randomly selecting the first portion of the forecasted data.

5. The method of claim 4, wherein:
the first portion of the forecasted data comprises a first forecasted data value from a first external data source of the external data sources; and
the second portion of the forecasted data comprises a second forecasted data value from a second external data source of the external data sources, the second forecasted data value representing a same condition at a same point in time as the first forecasted data value.

6. The method of claim 3, wherein making the determination comprises:
using the first sub-set of the mixed input data set and at least one inference model to obtain a first prediction of a plurality of predictions; and
using the second sub-set of the mixed input data set and the at least one inference model to obtain a second prediction of the plurality of predictions,
wherein the plurality of predictions each indicate whether a future state will occur.

7. The method of claim 6, wherein making the determination further comprises:
analyzing at least the plurality of predictions to obtain a statistical characterization regarding agreement in the at least the plurality of predictions;
making a second determination regarding whether the statistical characterization meets criteria; and
in an instance of the second determination in which the statistical characterization meets the criteria:
concluding that the policy is invoked.

8. The method of claim 7, wherein the statistical characterization comprises at least one quantity selected from a group consisting of:
a mean;
a median;
a mode; and
a standard deviation.

9. The method of claim 1, further comprising:
prior to obtaining the mixed input data set:
performing an analysis process using the forecasted data to obtain a forecasted data statistical characterization, the forecasted data statistical characterization indicating variability in forecasted data values of the forecasted data; and
using the forecasted data statistical characterization to obtain the mixed input data set so that the mixed input data set comprises a representation of the variability in the forecasted data values.

10. The method of claim 1, wherein forecasted data values of the forecasted data are obtained from the external data sources that each use different forecasting models and/or different input data for forecasting models with respect to others of the external data sources, and each of the external data sources providing limited access to information regarding the forecasted data values.

11. A non-transitory machine-readable medium having instructions stored therein, which when executed by a processor, cause the processor to perform operations for managing operation of one or more data processing systems, the operations comprising:
obtaining live data, the live data comprising measurements indicating operational conditions for the one or more data processing systems;
obtaining, from external data sources, forecasted data related to the operational conditions, the forecasted data being generated using proprietary methods;
performing a sampling process, using the forecasted data, to obtain a mixed input data set, the mixed input data set comprising the live data and at least a portion of the forecasted data;
making a determination, based on at least the mixed input data set, regarding whether a policy of a set of existing policies is invoked, the policy comprising an action set usable to update operation of the one or more data processing systems;
in an instance of the determination in which the policy is invoked:
performing the action set to update the operation of the one or more data processing systems; and
providing, based on the updated operation of the one or more data processing systems, computer-implemented services.

12. The non-transitory machine-readable medium of claim 11, wherein the measurements comprise quantifications of uncertainty and the forecasted data do not comprise quantifications of uncertainty.

13. The non-transitory machine-readable medium of claim 11, wherein the mixed input data set comprises:
a first sub-set comprising a first portion of the forecasted data and the live data; and
a second sub-set comprising a second portion of the forecasted data and the live data.

14. The non-transitory machine-readable medium of claim 13, wherein performing the sampling process comprises randomly selecting the first portion of the forecasted data.

15. The non-transitory machine-readable medium of claim 14, wherein:
the first portion of the forecasted data comprises a first forecasted data value from a first external data source of the external data sources; and
the second portion of the forecasted data comprises a second forecasted data value from a second external data source of the external data sources, the second forecasted data value representing a same condition at a same point in time as the first forecasted data value.

16. A data processing system, comprising:
a processor; and
a memory coupled to the processor to store instructions, which when executed by the processor, cause the processor to perform operations for managing operation of one or more data processing systems, the operations comprising:
obtaining live data, the live data comprising measurements indicating operational conditions for the one or more data processing systems;
obtaining, from external data sources, forecasted data related to the operational conditions, the forecasted data being generated using proprietary methods;
performing a sampling process, using the forecasted data, to obtain a mixed input data set, the mixed input data set comprising the live data and at least a portion of the forecasted data;
making a determination, based on at least the mixed input data set, regarding whether a policy of a set of existing policies is invoked, the policy comprising an action set usable to update operation of the one or more data processing systems;
in an instance of the determination in which the policy is invoked:
performing the action set to update the operation of the one or more data processing systems; and
providing, based on the updated operation of the one or more data processing systems, computer-implemented services.

17. The data processing system of claim 16, wherein the measurements comprise quantifications of uncertainty and the forecasted data do not comprise quantifications of uncertainty.

18. The data processing system of claim 16, wherein the mixed input data set comprises:
a first sub-set comprising a first portion of the forecasted data and the live data; and
a second sub-set comprising a second portion of the forecasted data and the live data.

19. The data processing system of claim 18, wherein performing the sampling process comprises randomly selecting the first portion of the forecasted data.

20. The data processing system of claim 19, wherein:
the first portion of the forecasted data comprises a first forecasted data value from a first external data source of the external data sources; and
the second portion of the forecasted data comprises a second forecasted data value from a second external data source of the external data sources, the second forecasted data value representing a same condition at a same point in time as the first forecasted data value.
